(19) United States
(12) Patent Application Publication
(10) Pub. No.: US 2007/0298373 A1
(43) Pub. Date: Dec. 27, 2007

(54) IMPLANTOLOGICAL SPACING DEVICE AND IMPLANTOLOGICAL GUIDE INSTRUMENT FOR AN IMPLANTOLOGICAL SPACING DEVICE

(75) Inventors: Andreas Lette, Traun (AT); Juergen Brandner, St. Georgen (AT)

Correspondence Address: KLARQUIST SPARKMAN, LLP, 121 SW SALMON STREET, SUITE 1600, PORTLAND, OR, 97204, US

(73) Assignee: W&H Dentalwerk Burmoos GmbH

(21) Appl. No.: 11/425,986

(22) Filed: Jun. 22, 2006

(51) Int. Cl. A61C 19/04

(52) U.S. Cl. 433/72

(57) ABSTRACT

A spacing device for fixing the position of an implant cavity in which a dental implant may be inserted, and a implantological guide instrument, particularly for use in jaw surgery, with a spacing device for guiding a drill mounted on a dental instrument for drilling the implant cavity, are described. One embodiment of the spacing device includes a positioning instrument that is designed such that it is attachable to the neck of a tooth or a dental prosthesis. A further embodiment of a spacing device is provided with an attachment portion or mechanism for connecting the spacing device to a dental instrument. The guide instrument is attachable to the spacing device and equipped with a guide bush, guide pins, a slide bush and a mounting portion to ensure that the user is able to carry out a cavity drilling procedure safely and easily.

### BACKGROUND

The present invention relates to a spacing device for fixing the position of an implant cavity in which a dental implant may be inserted, and to an implantological guide instrument with a spacing device of such kind for guiding a drill mounted on a dental instrument for drilling the implant cavity. The present invention further relates to a set of tools for drilling implant cavities with a spacing device of such kind, and to an aid to selecting a spacing device according to the invention, and to a method for manufacturing such a spacing device.

A spacing device of such kind is known from Patent No. EP 689 804 A1. The object of this device is to define the distance between adjacent implant cavities when two or more adjacent bores (implant cavities) are being drilled in a jaw, into which implants will subsequently be screwed as the base for a dental prosthesis (crown), and to indicate the spacing during drilling. The spacing device includes a positioning element in the form a post, which is inserted in a previously created bore, and a flared indicator portion whose horizontal length fixes the space between two implant cavities. The distal end of the indicator portion is constructed as a chamfered support for the drill on the dental instrument.

The drawback of this spacing device is that the horizontal length of the indicator portion is related solely to the dimensions of the implants. This spacing device does not allow the medical-biological requirements of the bone tissue to be taken into account. Accordingly, there is a risk that implants which are inserted using this spacing device may become loose due to degeneration of the bone tissue, which in turn may necessitate undesirable follow-up treatment and create the danger that further settings of implants may be impossible.

A further disadvantage of the spacing device of EP '804 is that the groove-like support element does not offer adequate support and/or guidance for the drill on the dental instrument, which means that the implant cavity to be drilled may not have the desired alignment or parallelism with the first cavity. In particular, it is difficult to rest and position the drill in the support groove in the oral cavity, where space is limited and visibility is sometimes poor.

A further disadvantage of the spacing device described in EP '804 is that it cannot be inserted until the dentist has made a first bore. This first bore must be made either freehand or with a template that is difficult to manufacture.

### SUMMARY

One object of the present invention is therefore to provide a spacing device that also takes into account the medical-biological requirements of the jaw bone tissue, and a method for manufacturing such a spacing device.

A further object of the present invention is therefore to provide a spacing device that may be applied for the drilling of a first bore, taking into account the dimensions of the implant to be inserted therein and of the neighbouring tooth as well as the medical-biological requirements of the bone tissue, and a method for manufacturing a spacing device of such kind.

In one embodiment of a spacing device, the distance between the positioning element and the support element for the drilling tool (dentist's drill) is a function of the measurement, i.e., of the diameter or diameters of the implants to be inserted, and a function of the biological width, the value of which is between 1.4 and 3.2 mm, with the result that implants and the dental prosthesis are able to be seated more reliably and more naturally. The term “biological width” refers to the distance between two teeth or dental prostheses or between one tooth and a prosthesis at the basis of the jaw to which the teeth or dental prostheses are attached (see FIG. 6, in which the biological width is indicated by bB). In this area between the teeth or dental prostheses, the jawbone forms a ridge that rises slightly above the level of the surrounding jawbone, so that each tooth is embedded in its own socket, formed by the ridges on either side of the tooth. Oral mucosa grows over these ridges to form the papilla.

It is essential to consider the biological width when inserting implants, to ensure that the jawbone between the dental prostheses (implants, crowns) or between a healthy tooth and the prosthesis is preserved. If the biological width is not considered when the implant cavities are drilled, i.e., if the prostheses are placed too close together, the danger arises that the jawbone in this area will be undersupplied, causing degeneration of the bone tissue. As a result, the prosthesis will be poorly seated and likely to become loose. If the biological width is less than 1.4 mm, the risk of undersupply of the ridge of the jaw bone increases substantially.

The invention provides for multiple implementations of the spacing device. A first design is used to determine the position of an implant cavity that is adjacent a living tooth or a dental prosthesis that is already complete and securely attached to the jaw. In a first step, the user must define the diameter of the implant that he subsequently intends to set on the tooth or prosthesis, and then he must select the appropriate spacing device according to the invention. Using the positioning element, he then positions this spacing device on a part of the jaw on which he intends to drill the implant cavity in such a way that the spacing device is in contact with the tooth or dental prosthesis. As soon as the spacing device is positioned on the jaw, the support element for the drilling tool indicates the point on the jaw at which the implant cavity is to be drilled, the biological width already being taken into account due to the predetermined and fixed, i.e., unchangeable, distance between the positioning element and the support element. The user thus advantageously does not need to make allowance for the biological width actively when determining the site where the implant cavity is to be drilled, and the risk that that user may neglect to consider the biological width is eliminated. Moreover, the support element is situated precisely at the point where the drill is applied for drilling the implant cavity, thereby ensuring a firm support and guidance for the drill when it engages with the jaw and throughout the drilling procedure.

In this first embodiment of the spacing device, distance D1 between the positioning element and the support element is described by the equation D1=L_{(1,2,3)}/2+bB, where L_{(1,2,3)} represents the diameter of the implant that is to be inserted in the implant cavity that is to be created using the spacing device, and bB represents the biological width of 1.4-3.2 mm, preferably 1.5-2.1 mm, particularly 1.8-2.0 mm. FIG. 7 shows three implants for purposes of understanding, and in which each implant has a separate diameter, L₁, L₂, L₃.

A second embodiment is used to determine the distance between a first implant cavity that has already been drilled and a second, adjacent implant cavity that is to be drilled, wherein a dental prosthesis has not yet been fixed in either cavity. In this ease too, the user must define the diameters of both the implants that are to be inserted and select the appropriate spacing device according to the invention before he makes use of the spacing device. He then uses the positioning element to position the selected spacing device in the first implant cavity in such manner that the support element for the drill indicates the precise site on the jaw where the second implant cavity is to be drilled. Again, allowance is made for the biological width because of the predetermined and fixed, i.e., unchangeable, distance between the positioning element and the support element.

In this second embodiment of the spacing device, distance D2 between the positioning element and the positioning element is described by the equation D2=L_{(1,2,3)}/2+L_{(1,2,3)}/2+bB, where L_{(l,2,3)} represents the diameter of a first and second implant, which are to be inserted in the first and second, adjacent implant cavities, at least one implant cavity being able to be produced with the aid of the spacer. bB is the biological width of 1.4-3.2 mm, preferably 2.0-3.2 mm, particularly 2.5-3.0 mm.

In both embodiments of the spacing device, the support element for the drill may be provided by any known arrangement, for example by a groove in the distal end of the spacing device. However, it preferably has the form of a port or a sleeve-like protrusion that serves to reinforce the support and guidance effect for the drill.

The positioning element in the second embodiment of the spacing device may have any geometrical shape and design that is able to be accommodated in the first implant cavity, for example it may be a rounded or angular protrusion or a bush. It is preferably designed as a pin that extends approximately into the upper third of the first implant cavity, thus enabling stable, non-slip positioning of the spacing device.

Compared with known spacing devices, this spacing device ensures reproducible use that is adapted to various implants and takes into account the biological width.

The method for producing a spacing device according to the invention, in which distance D1, D2 between the port for the drill and the positioning element is fixed, comprises the following steps:
Determining a distance D1 on the basis of the equation D1=L_{(1,2,3)}/2+bB or determining a distance D2 on the basis of the equation D2=L_{(1,2,3)}/2+L_{(1,2,3)}/2+bB, where L_{(1,2,3)} is equal to the diameter of a first or a first and second implant, and the value of the biological width bB is between 1.4 and 3.2 mm,
Providing a workpiece,
Machining, preferably milling the workpiece in such manner that the positioning element is located at the calculated distance D1 or D2 from the support element

Such a method enables the device to be produced simply and inexpensively from a single workpiece. The workpiece is preferably made from rustless chromed steel or titanium, so that the spacing device is also able to withstand cleaning and sterilisation procedures for repeated use. Alternatively, the spacing device may be produced by metal powder injection moulding (MIM process).

Yet another object of the present invention is to provide an implantological guide instrument that offers the user improved resting and positioning capability for the dental instrument before the drilling procedure and more reliable guidance and support for the tool and the dental instrument during the drilling procedure.

In one embodiment thereof, the implantological guide instrument is attached to an implantological spacing device or is equipped with a connecting portion or element for attachment to an implantological spacing device. Of course, the implantological guide instrument according to the invention may also be attached to any known spacing device or may include the necessary connecting fixtures for attaching these known spacing devices.

The connecting fixture for attaching a spacing device according to the invention or other spacing device is preferably designed as a detachable connection fixture, particularly preferably as a threaded, socket, latch or clamp fixture, so that the user is able to use various spacing devices, preferably the first and second embodiments of the spacing device according to the invention, with a single guide instrument.

In order to ensure the most reliable guidance possible of the drill, the guide instrument includes a guide bush, which accommodates and guides the tool. The diameter of the guide bush is preferably only slightly larger than the diameter of the drill tool, thereby minimising the risk that the drill will become misaligned during the procedure.

In a preferred embodiment, at least one guide pin is disposed on the guide bush to guide the dental instrument. In a first configuration, the dental instrument is advanced along this at least one guide pin during the drilling procedure. Particularly preferably, a plurality of guide pins are provided and are arranged so that at least a part of the dental instrument to be guided, particularly the instrument head, may be inserted between the guide pins, thereby providing improved guidance and support. In an alternative configuration, the dental instrument may be moved together with the at least one guide pin relative to the guide bush. The guide instrument preferably includes a slide bush for accommodating at least a part of the dental instrument that is to be guided, the slide bush being furnished with a borehole for each guide pin, and which is engaged by a portion of the guide pin, As the implant cavity is being drilled, the slide bush and the dental instrument located therein are advanced together with the at least one guide pin or along the at least one guide pin.

The at least one guide pin is preferably arranged in a bearing block, which is connected to the guide bush.

In a particularly preferred embodiment, a mounting device is provided for at least a part of the dental instrument, preferably the instrument head, and is attached to the slide bush. The mounting device is advantageously designed with a portion that detachably engages wit the dental instrument, for example a threaded, socket, latch or clamped connection, so that the guide instrument is firmly attached to the dental instrument. The user is thus able to attach the guide device, and preferably the spacing device as well, to the dental instrument outside the patient's oral cavity before the start of treatment. At the start of treatment, all that needs to be done is to position the assembled treatment instrument, consisting of the dental instrument, the guide instrument and the spacing devices on the patient's jaw. Unlike the related art, it is thus no longer necessary to rest and position the dental instrument and the drill on the jaw or on the guide instrument in the oral cavity, where space is limited and visibility is poor. The mounting device is designed to be rotatable relative to the slide bush to simplify the operation further, so that the user is able to rotate the dental instrument relative to the guide instrument during the treatment.

### BRIEF DESCRIPTION OF THE DRAWINGS

The invention will be explained in the following on the basis of preferred embodiments and with reference to the accompanying drawings:

FIGS. 1A and 1B show a perspective view and a cross section, respectively, of a first embodiment of the spacing device.

FIGS. 2A and 2B show a perspective view and a cross section, respectively, of a second embodiment of the spacing device.

FIG. 3 shows a set of tools for drilling implant cavities.

FIGS. 4A and 4B show a perspective view and a cross section, respectively, of the implantological guide instrument with the spacing device.

FIG. 5 shows an aid for selecting a spacing device according to the invention in the form of a chart.

FIG. 6 shows an implantological guide instrument together with a spacing device attached to a dental instrument with a tool for drilling implant cavities in a jaw.

FIG. 7 shows three implants of different sizes.

### DETAILED DESCRIPTION

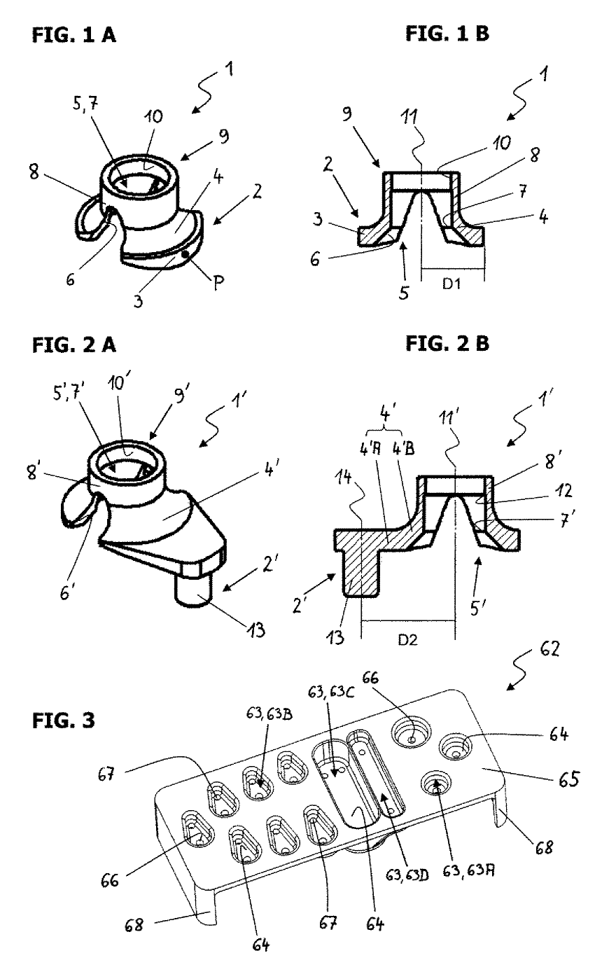

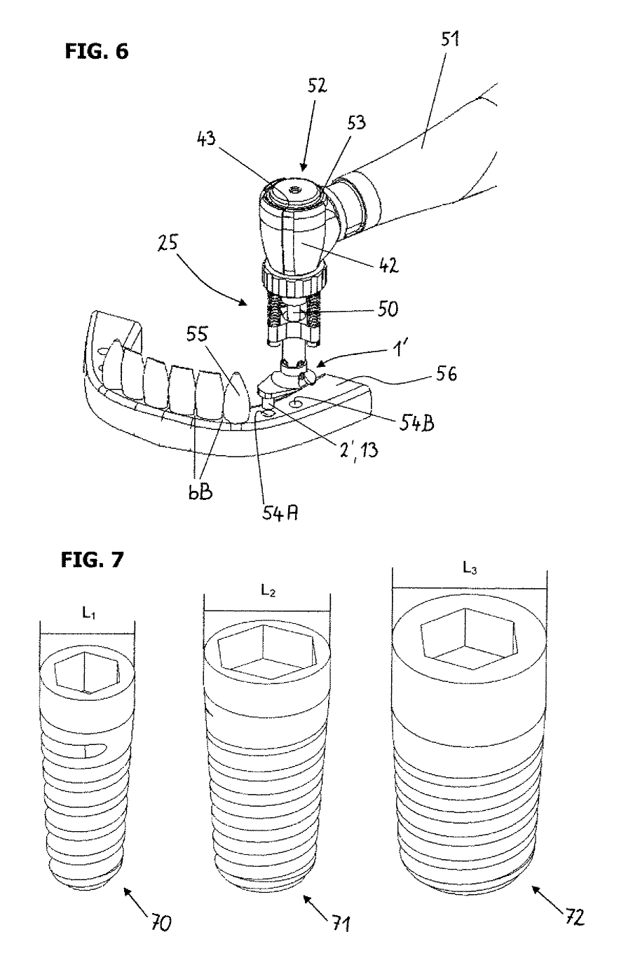

Spacing device 1 of FIGS. 1A and 1B is used to fix the position of an implant cavity 54A (see FIG. 6) that is adjacent a living tooth 55 or a dental prosthesis that has already been completed and firmly implanted on the jaw. It includes a positioning element 2, which has the form of a shoulder 3 for example, and a contact point P, with which shoulder 3 contacts a tooth 55 or dental prosthesis that is adjacent this section of jaw 56 as soon as spacing device 1 is placed on the jaw section 56 in which implant cavity 54A is to be drilled. Contact point P touches tooth 55 or the dental prosthesis in the area of the neck of the tooth or dental prosthesis on the side which is closest to jaw section 56 (the mesial or distal side). Shoulder 3 may particularly be circular or arcuate, contact point P being arranged on the outer circumference of the circle or arc.

Positioning element 2 and/or shoulder 3 are preferably shaped such that the user may put them optimally against the neck of the adjacent tooth 55 or dental prosthesis, i.e., element 2 is conformed such that it is detachably attachable to the neck of a tooth 55 or a dental prosthesis, in particular that it is able to lie essentially flush against the neck. In particular, they are adapted to the shape of the neck of the tooth 55 or dental prosthesis, i.e., they have a height of about 0.8-1.2 mm, preferably 1.0 mm, and may be straight or curved, particularly circular or arcuate. Alternatively, positioning element 2 may also be designed as a flange.

Positioning element 2 is attached to support device 5 for drilling tool 50 via web 4. Web 4 and positioning element 2 include at least one, preferably two cut-outs 6 so that web 4 and positioning element 2 are divided into to arcuate sections. The at least one cut-out 6 enables the user to see inside spacing device 1 and support device 5, and to monitor drilling tool 50 while implant cavity 54A is being drilled.

A marking is preferably applied to web 4 so that the user is able to tell different spacing devices 1 apart easily. The marking may have the form or one or more alphanumeric characters, symbols, or a coloured patch.

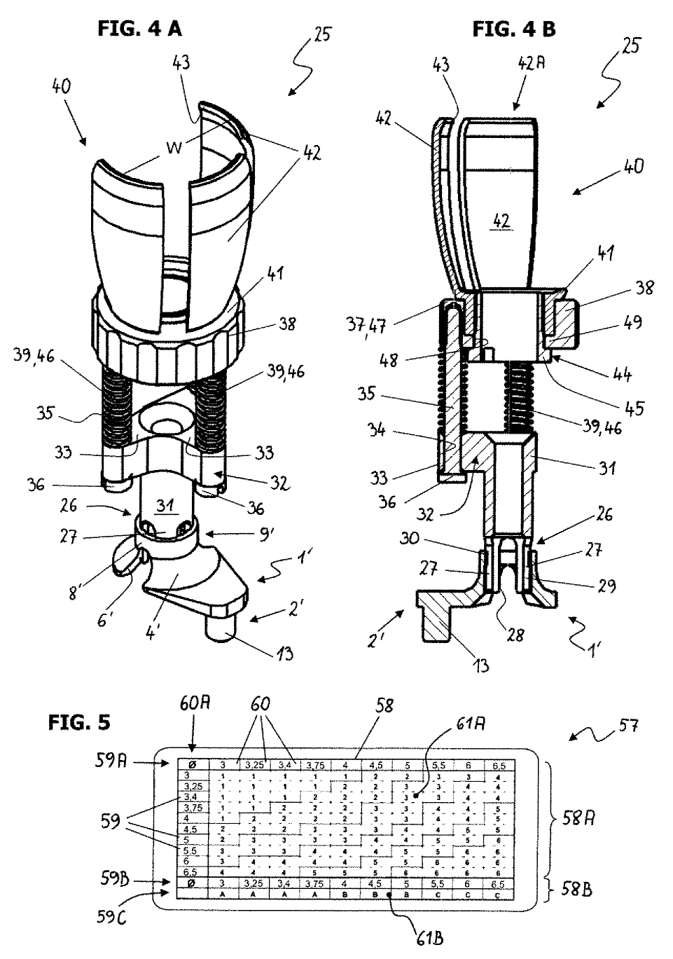

Support device 5 has the form of a circular port 7, but it may also have other geometrical shapes. The size of the diameter of port 7 is such that spacing device 1 is able to be used with all known drilling tools. A connecting bush 8 is connected to port 7, and improves the support and guidance of drilling tool 50. Connecting bush 8 preferably includes an attachment portion or mechanism 9 for attaching spacing device 1 to a guide instrument for use in implantological, particularly jaw surgery, for example guide instrument 25 (see FIGS. 4A, 4B). Attachment mechanism 9 is preferably constructed as a detachable connecting device, particularly as a threaded, socket, latch, or clamped connection. A shoulder 10 is shown as an example of such a socket connection in FIGS. 1A and 1B.

FIG. 1B also shows the centreline 11 of support device 5. According to the invention, distance D1 between centreline 11 and positioning element 2, particularly contact point P of shoulder 3, is equal to the sum of half the diameter L₁ or L₂ or L₃ of the respective implant 70-72 (see FIG. 7) that is to be inserted in implant cavity 54A which is created with the aid of spacing device 1, and the biological width bB, which has a value from 1.4-3.2 mm, preferably from 1.5-2.1 mm, particularly from 1.8-2.0 mm (D1=L_{(1,2,3)}/2+bB).

Spacing device 1′ of FIGS. 2A and 2B is used to determine the distance between a first implant cavity 54A, which has already been drilled, and a second, adjacent implant cavity 54B, (see FIG. 6), in which no dental prostheses have yet been placed in either of import cavities 54A, 54B. Positioning element 2′ is configured as a cylindrical pin 13, whose diameter is selected such that the user is able to insert it in the first, drilled implant cavity 54A. Web 4′ for attaching positioning element 2′ to support device 5′ includes a first, essentially horizontal web section 4′A and a second web section 4′B that is tapered towards support device 5′. Here too, a marking consisting of one or more alphanumeric characters, symbols or a coloured patch may be disposed on one of web sections 4′A and 4′B.

The other components of spacing device 1′, i.e., cut-out 6′, connecting bush 8′, port 7′ that forms support device 5′, and attachment mechanism 9′ are equivalent to the components of spacing device 1. Shoulder 10′ of attachment mechanism 9′ is shown for exemplary purposes as part of latching mechanism, with a recess 12 on the end thereof facing web 4′, which recess is engaged by corresponding latching elements (for example catch 29) on the implantological guide instrument 25 that is attachable to spacing device 1′ (see FIGS. 4A, 4B).

FIG. 2B shows centreline 14 of positioning instrument 2 and centreline 11′ of support device 5′. The distance D2 between centreline 11′ and centreline 14 is equal to the sum of half the respective diameters L₁ or L₂ or L₃ of the first or second implant 70-72 (see FIG. 7) that is to be inserted in the first and second implant cavity 54A, 54B, which are adjacent one another, wherein at least one implant cavity 54A, 54B is able to be created using spacing device 1′, and the biological width bB, which has a value from 1.4-3.2 mm, preferably from 2.0-3.2 mm, and particularly from 2.5-3.0 mm (D2 L_{(1,2,3)}/2+L_{(1,2,3)}/2+bB).

FIGS. 4A and 4B show a implantological guide instrument 25, particularly for use in jaw, surgery, that is attached to spacing device 1′. Spacing device 1 may also be attached to guide instrument 25 in the same way instead of spacing device 1′. Of course, implantological guide instrument 25 according to the invention may also be attached to other spacing devices and may include corresponding connecting fixtures for attaching these spacing devices, and conversely the spacing device 1 according to the invention may also be attached to other guide instruments and furnished with corresponding connecting fixtures for attachment to such other guide instruments.

Guide instrument 25 includes a connection portion or fixture 26 that is shown here for exemplary purposes as a detachable latching connection. Connection fixture 26 consists of at least one spring arm, preferably three spring arms 27, which are separated from each other by recesses 28. Each spring arm 27 has a catch 29 and a recess 30. When guide instrument 25 is connected to a spacing device, for example spacing device 1′, catches 29 engage behind shoulder 10′ of attachment mechanism 9′ on spacing device 1′ and engage in recess 12 that is adjacent shoulder 10′. Shoulder 10′ engages in recess 30 on the at least one spring arm 27 in the same way. In order to provide a connection between spacing device 1′ and guide instrument 25 that is easily coupled by the user but is also reliable and not too easily disengaged, the at least one spring arm 27 is biased slightly outwards, but is designed to be elastic radially inwardly, so that catch 29 is able to slide past shoulder 10′ without the need to apply too much force when coupling.

When the connection is made, recess 28 and cut-out 6′ on spacing device 1′ are preferably situated opposite one another, affording the user the best possible view of drilling tool 50.

Guide means, preferably a guide bush 31, is arranged next to connection fixture 26, and this means seats, guides and supports drilling tool 50. The internal diameter of guide bush 31 is preferably about 2.05-2.20 mm, only slightly larger than the diameter of drilling tool 50, so that guide bush 31 particularly provides good support. At least one guide pin 35 and preferably three guide pins 35 are arranged on guide bush 31. Guide pins 35 serve to guide dental instrument 51 while implant cavity 54A, 54B is being drilled, they preferably guide instrument head 52 of dental instrument 51 (see FIG. 6).

A bearing block 32 is arranged on the end of guide bush 31 farthest from connection fixture 26, and has a larger diameter than that of guide bush 31. Bearing block 32 includes one or more wings 33, each of which is furnished with at least one borehole 34. Guide pins 35 are engaged in boreholes 34 through sliding fits and the first end thereof protrudes through boreholes 34 pointing away from guide bush 31. The other end of each of the guide pins 35 is furnished with a limit stop 36, which has a larger diameter than the diameter of pins 35 and that of boreholes 34.

A section of at least one guide pin 35 engages in a borehole 37 in a slide bush 38, preferably with a threaded connection. Borehole 37 is preferably designed as a blind hole 47, so that the first end of the at least one guide pin 35 is seated therein, thereby preventing particles and dirt from penetrating and collecting as far as possible. Slide bush 38 serves as a support for at least a part of the dental instrument 51 to be guided, preferably the instrument head 52, and includes a borehole 48 through which drilling tool 50 may pass. When dental instrument 51 is supported on slide bush 38 and when a force is exerted on the slide bush 38 by dental instrument 51, as would happen for example while drilling an implant cavity, slide bush 38 moves together with guide pins 35 towards guide bush 31, and guide pins 35 slide through boreholes 34 in bearing block 32.

At least one spring element 39 is preferably disposed between guide bush 31 or bearing block 32 and slide bush 38, and this spring element biases slide bush 38 against guide bush 31. A plurality of spring elements 39 is preferably provided, and these are configured particularly preferably as helical springs 46, one guide pin 35 being arranged inside each helical spring 46. The diameter of the boreholes 34 on bearing block 32 is smaller than that of spring element 39, which means that spring element 39 rests on the side of bearing block 32 that faces slide bush 38. The at least one spring element 39 has the advantageous effect that, in the unloaded condition, for example before the start of drilling implant cavity 54A, 54B, slide bush 38 on guide instrument 25 is always positioned as far as possible from guide bush 31, this distance being such that, when guide instrument 25 is connected to a spacing device 1, 1′ and a dental instrument 51 on which a drilling tool is mounted, the tip of drilling tool 50 protrudes only very slightly, or not at all beyond spacing device 1, 1′. As a result, the user is able to manipulate spacing device more 1, 1′ easily and position spacing device 1, 1′ safely on jaw 56. When pressure is applied to slide bush 38, slide bush 38 must be moved together with the at least one guide pin 35 against the spring force of the at least one spring element 39 and towards guide bush 31. As soon as the force is removed from slide bush 38, slide bush 38 automatically returns to a position as far as possible from guide bush 31. In addition, spring element 39 acts as a limit stop which, when fully compressed, limits the penetration depth of drilling tool 50, thus preventing the user from drilling too deeply into jaw section 56.

The outer circumference of slide bush 38 is preferably furnished with a knurled pattern so that the user is more easily able to manipulate guide instrument 25 and particularly the connection with dental instrument 51.

A mounting device 40 for at least a part of dental instrument 51, preferably the instrument head 52, is attached to slide bush 38. In a preferred embodiment, mounting device 40 is arranged rotatably relative to slide bush 38, so the user is able to rotate dental instrument 51 relative to guide instrument 25 and spacing device 1, 1′ when he is positioning spacing device 1, 1′ on jaw section 56 and during the procedure. A clamp ring 44 that protrudes through borehole 48 in slide bush 38 is provided for this purpose, and flange 45 of clamp ring 44 lies flush with the side of slide bush 38 that faces guide bush 31. Clamp ring 44 is for example screwed or bonded to carrying sleeve 41 of mounting device 40 in such manner that base surface 49 of slide bush 38 is taken up in sliding manner between flange 45 and carrying sleeve 41.

Besides the cylindrical carrying sleeve 41, mounting device 40 preferably also includes at least two spring-loaded wings 42. The clearance W between the at least two spring-loaded wings 42 is of such size that instrument head 52 may be inserted therebetween, clearance W being smaller than the diameter of instrument head 52, so that when instrument head 52 is inserted in mounting device 40, wings 42 are biased radially outwards and are at least partly resting on instrument head 52 due to their concave shape, and form a detachable connection with instrument head 52. In a particularly preferred configuration, free end 42A of at least one wing 42 has a protruding edge 43 which engages in a recess 53 on instrument head 52 when instrument head 52 is inserted in mounting device 40. Mounting tool 40 may advantageously be used to attach guide instrument 25 and spacing device 1, 1′ to dental instrument 51, and the entire instrument assembly, including the dental instrument 51, the guide instrument 25, and the spacing device 1, 1′ may be positioned easily on jaw 56, as is shown for exemplary purposes in FIG. 6.

Besides the instrument assembly, which includes the dental instrument 51, the guide instrument 25, and the spacing device 1′, FIG. 6 also shows a section of jaw 56 in which several implant cavities are to be created. A first implant cavity 54A has already been drilled next to a living tooth 55, preferably using a spacing device 1 (see FIGS. 1A, 1B). A second implant cavity, 54B, has just been drilled next to first implant cavity 54A using the spacing device 17. At that time, positioning element 2′ in the form of a pin 13 was inserted in first implant cavity 54A, thereby fixing the selected distance of the implant cavity 54B that is to be drilled. It is possible to drill at least one more implant cavity in jaw section 56 in the same way, in which case the user may used the same spacing device 1′ or a different spacing device providing for a different distance between positioning element 2′ and support element 5′, depending on the implant 70-72 that is to be fixed. In the latter case, the user would remove spacing device 1′ from guide instrument 25 and would connect a different spacing device to guide instrument 25.

The user makes the decision regarding which spacing device 1, 1′ to use, taking into account the implant or implants 70-72 that is/are to be implanted in jaw section 56, before starting the actual drilling procedure. The selection of the implant depends among other things on the contour and bone thickness of jaw section 56 as well as the nature of the dental prosthesis that is to be implanted. For example, if the user intends to fix implant 71 with a diameter L₂ in implant cavity 54A, he must use a spacing device 1 for which distance D1 between support element 5 and positioning element 2 is equal to D1=L₂/2+bB. The procedure is the same if the user wants to use implant 70 with diameter L₁ or implant 72 with diameter L₃.

For the subsequent drilling of implant cavity 54B, the user must again decide which implant 70-72 to insert in cavity 54B. For example, if he selects implant 72 with diameter L₃, then he must use spacing device 1 for which distance D2 between support element 5′ and positioning element 2′ is equal to D2=L₂/2+L₃/2+bB, where the term L₂/2 is calculated from the previously selected implant 71, with diameter L₂, the diameter for the adjacent implant cavity 54A. The user proceeds similarly if he wishes to drill another implant cavity—not shown—in jaw section 56, in which case the distance for the spacing device 1′ to be used will be equal to D2=L₃/2+L_{(1,2,3,)}/2+bB, where L₃/2 is calculated from the previously selected implant 72, with diameter L₃, and the ten L_{(1,2,3)}/2 stands for the implant 70, 71 or 72 that is to be set in the implant cavity which is not shown and that has not yet been selected by the user. Of course, there are more than three implants with different diameters, and implants 70-72 in FIG. 7 are shown for exemplary purposes only, to explain the procedure, and the basic principle of selecting the spacing device 1, 1′ based on the diameter of the respective implant(s) may be applied for all known dental implants.

It is apparent from the preceding description that a separate spacing device 1′ with corresponding distance D2 between support element 5′ and positioning element 2′ must be provided for every possible arrangement of two implants with the same or different diameters in adjacent implant cavities 54A, 54B. In view of the large number of implants, as indicated above, that are offered by various manufacturers, this would mean that the user would need to be able to use an enormous variety of spacing devices 1′. A preferred embodiment takes advantage of the natural variability of the biological width bB to reduce the number of different spacing devices 1′ to a quantity that is reasonable for both the manufacturer and the user. Like many natural biological systems, the biological width bB between healthy teeth is not a constant, its value depends on the type of tooth (incisors, molars, etc.), the size of the jaw, the position of the tooth etc., the biological width bB typically lying in a range from 1.4-3.2 mm. It follows that a spacing device 1′ with a fixed, unchangeable distance D2 between support element 5′ and positioning element 2′ is able to be used for multiple combinations of the same or different implants, while the biological width bB varies within the range 1.4-3.2 mm depending on the diameters of the implants used.

FIG. 5 shows an aid 57 to help the user select a spacing device 1 or 1′, preferably in the form of a chart 58, which serves to explain the use of a spacing device 1′ for multiple combinations of the same or different implants; chart 58 consists of a first sub-chart 58A for spacing devices 1′ and a second sub-chart 58B for spacing devices 1. Sub-chart 58A consists of multiple rows 59 and multiple columns 60. First row 59A and first column 60A list the diameters of various implants, including for example implants 70-72. The values listed in row 59A (or the values listed in column 60A) indicate the diameter of the implant in millimetres for the first implant cavity 54A, which has already been drilled, and they therefore correspond to the first tern L_{(1,2,3)}/2 in the equation D2=L_{(1,2,3)}/2+L_{(1,2,3)}/2+bB. The values listed in column 60A (or the values listed in row 59A) indicate the diameter of the implant in millimetres for the second implant cavity 54B, which has not yet been drilled, thus corresponding to the second term L_{(1,2,3)}/2 in this equation. The FIGS. 1-6 listed in the results matrix 61A correspond to six different spacing devices 1′, which are also arranged on the respective spacing device 1′, preferably on the web 4′ thereof making it easier for the user to identify the spacing device 1′ that is determined using the aid 57.

To select the appropriate spacing device 1′, the user looks for the diameter of the implant he intends to set in implant cavity 54A in row 59A. He then searches column 60A for the diameter of the implant he intends to set in implant cavity 54B. In result matrix 61A, he then identifies the cell at the intersection between the column following the diameter of the implant for implant cavity 54A and the row next to the diameter of the implant for implant cavity 54B. The number in this cell indicates the spacing device 1′ that is to be used.

If the user wants to use two implants next to each other, and both have a diameter of 3 mm, aid 57 indicates use of the spacing device 1′ that is identified by FIG. 1. For example, distance D2 between support element 5′ and positioning element 2′ (pin 13) of the spacing device 1′ identified with the FIG. 1 is 6.1 mm. Applying the equation D2=L_{(1,2,3)}/2+L_{(1,2,3)}/2+bB thus yields:

6.1 mm=3/2 mm+3/2 mm+bB, where the biological width bB is 3.1 mm. If the user wants to set two implants next to one another and the first implant has a diameter of 3 mm while the second has a diameter of 4 mm, aid 57 also indicates the use of the spacing device 1′ designated by FIG. 1. Applying the equation D2=L_{(1,2,3)}/2+L_{(1,2,3)}/2+bB then yields:
6.1 mm=3/2 mm+4.2 mm+bB, and the biological width bB is 2.6 mm. In both cases, the value of the biological width bB thus falls within the desired range from 1.4-3.2 mm. The biological width bB also varies in the same way when the spacing devices 1′ designated by FIGS. 2-6 and different implants are used. By varying the biological width within the limits of 1.4-3.2 mm, it is possible to limit the number of spacing devices 1 to be used within reasonable limits for both users and manufacturers while taking into account the medical-biological requirements of the jaw's bone tissue.

Sub-chart 58B is used to select the appropriate spacing device 1 for fixing the position of an implant cavity 54A next to a living tooth 55 or a dental prosthesis that is complete and already set in the jaw. Sub-chart 58B consists of a first row 59B that lists the implant diameter in millimetres of the implant that is to be inserted in the implant cavity 54A to be drilled. Row 59C reflects result matrix 61B, though in this case the different spacing devices are identified with the letters A-C. In this case too, each spacing device 1 is able to be used for several implants with different diameters, and it is the biological width bB that varies. The case is illustrated with the example of spacing device 1 marked A: Distance D1 between support device 5 and positioning instrument 2 corresponds to the equation D1=L_{(1,2,3)}/2+bB and is 3.8 mm. For an implant with diameter 3.0 mm this yields:

3.8 mm=3/2 mm+bB and a value of 2.3 mm for the biological width bB. For an implant with a diameter of 3.75 mm, for which sub-chart 58B also indicates the use of the spacing device 1 marked A, this yields:
3.8 mm=3.75/2 mm+bB and a value of 1.925 mm for the biological width bB. Accordingly, the biological width bB lies in the desired range from 1.4-3.2 mm in both cases and, as for spacing device 1′, it is assured that the number of spacing devices 1 to be used remains within reasonable limits for both users and manufacturers while taking into account the medical-biological requirements of the jaw's bone tissue.

The different spacing devices may also be distinguished from each other in the result matrix 61A, 61B in aid 57 with identification systems other than numbers and letters, for example by symbols or colour coding.

In the embodiment shown aid 57 is used to determine the selection of three different spacing devices 1 and six spacing devices 1′. But aid 57 is not limited just to this number of spacing devices 1, 1′, of course it may also be used to make a selection from a larger or smaller number of spacing devices 1, 1′ or implant diameters by storing the corresponding number of markings for spacing devices 1, 1′ or implant diameters in result matrix 61A, 61B and rows 59A, 60A.

In order for it to be used effectively in a dental surgery, it is therefore advantageous if several different spacing devices 1, 1′ are available to the user, preferably four to ten spacing devices 1′, for determining distance D2 between a first implant cavity 54A that has already been drilled and a second, adjacent implant cavity that has not yet been drilled, and two to four spacing devices 1 for determining distance D1 and the position of an implant cavity 54A that is adjacent a living tooth 55 or a complete dental prosthesis that is already securely embedded in the jaw. The following table lists the respective distances D2 and D1 for a preferred embodiment with eight spacing devices 1′ (1-8) and three spacing devices 1(A-C):

| | Spacing device 1 | | |
|---|---|---|---|
| | A | B | C |
| Distance D1 [mm] | 3.8 | 4.3 | 5.6 |

| | Spacing device 1′ | | | | | | | |
|---|---|---|---|---|---|---|---|---|
| | 1 | 2 | 3 | 4 | 5 | 6 | 7 | 8 |
| Distance D2 [mm] | 6.1 | 6.6 | 7.1 | 7.6 | 8.0 | 8.6 | 9.1 | 9.6 |

Spacing devices 1, 1′ are preferably incorporated in a set of tools for drilling implant cavities. A preferred embodiment of such a set of tools is shown in FIG. 3 and identified by reference number 62. It includes several compartments 63 that have the form of depressions 64 in a carrier 65. The size of each depression 64 is such that it is able to accommodate at least one spacing device 1 or 1′, each depression 64 preferably has the same shape and dimensions as a given spacing device 1, 1′, thus forming first compartments 63A for spacing devices 1 and second compartments 63B for spacing devices 1′. In a particularly preferred configuration, a first borehole 66 is provided in the base of each compartments 63 containing a spacing device 1, 1′, which hole is positioned below support element 5, 5′ and port 7, 7′ when the spacing device 1, 1′ is placed in compartments 63. In this way, the user is able to attach the spacing devices 1, 1′ to the dental instrument 51 without picking them up by hand, even when a drilling tool 50 is already mounted on the dental instrument 51. The user attaches guide instrument 25 to dental instrument 51 and then presses connection fixture 26 of guide instrument 25 against attachment mechanism 9, 9′ of the spacing device 1, 1′ arranged in the toolkit 62, wherein the compression and the consequent movement of the instrument head 52 with the drilling tool 50 cause the drilling tool 50 to protrude through bore hole 66 as a result of the action of spring elements 39.

A second borehole 67 is provided in each of the compartments 63B for spacing devices 1′ to accommodate pin 13, thereby improving the positioning of spacing devices 1′ in the compartments 63B and the connection with connection fixture 26 on guide instrument 25.

Toolkit 62 particularly preferably includes two additional compartments 63, wherein compartment 63C holds at least one implantological guide instrument, preferably guide instrument 25, particularly for jaw surgery, and compartment 63D holds at least one drilling tool 50. In addition, at least one further compartment may be provided for storing at least one implant 70-72, and aid 57 for selecting a spacing device 1, 1′ may be supplied with toolkit 62. Toolkit 62 thus contains all the tools required for setting an implant in one compact well designed package.

In a further preferred embodiment, toolkit 62 is incorporated in a container, particularly a metal case with a lid. The toolkit 62 rests on two or more supports 68 in the container. In this embodiment, aid 57 for selecting a spacing device 1, 1′ may be applied to the lid of the container, for example by gluing or laser etching.

The invention is not limited to the embodiments described, it extends to all configuration variations that are in harmony with the theoretical, logically extended functional principle of the invention.

1. A spacing device for fixing the position of an implant cavity in which a dental implant can be inserted, the spacing device comprising:
a support device for a drilling tool that drills the implant cavity in the jaw; and
a positioning element for positioning the spacing device on the section of jaw where the implant cavity is to be created,
wherein a distance between the support device and the positioning element is fixed, and wherein the positioning element is configured such that it is attachable to the neck of a tooth or a dental prosthesis.

2. The spacing device as recited in claim 1, wherein the positioning element comprises a flange.

3. The spacing device as recited in claim 1, wherein the positioning element has a substantially curved shape.

4. The spacing device as recited in claim 1, wherein the positioning element has a substantially straight portion.

5. The spacing device as recited in claim 1, wherein the positioning element comprises a shoulder.

6. The spacing device as recited in claim 1, wherein the positioning element includes a contact point that contacts the neck of the tooth or dental prosthesis adjacent a section of the jaw where the implant cavity is to be created.

7. The spacing device as recited in claim 1, wherein the support device comprises an opening, to which a connecting bush is connected.

8. The spacing device as recited in claim 7, wherein the connecting bush includes an attachment portion for attaching the spacing device to a dental instrument.

9. The spacing device as recited in claim 8, wherein the attachment portion provides a detachable connection.

10. The spacing device as recited in claim 9, wherein the detachable connection comprises at least one of a threaded, plugged, latched and clamped connection

11. The spacing device as recited in claim 1, wherein the support device is connected to the positioning element via a web.

12. The spacing device as recited in claim 11, wherein the web has a section that tapers in the direction of the support device.

13. The spacing device as recited in claim 11, wherein the support device includes an opening, and wherein the web includes at least one cut-out in the opening.

14. A spacing device for fixing the position of an implant cavity in which a dental implant can be inserted, the spacing device comprising:
a support device for a drilling tool that drills the implant cavity in the jaw; and
a positioning element for positioning the spacing device on a section of jaw where the implant cavity is to be created,
wherein a distance between the support device and the positioning element is fixed, and wherein the spacing device is formed of a single piece.

15. The spacing device as recited in claim 14, wherein the spacing device is produced from a single workpiece by a machining process.

16. The spacing device as recited in claim 14, wherein the spacing device includes an attachment portion for attaching the spacing device to a dental instrument.

17. The spacing device as recited in claim 16, wherein the attachment portion provides a detachable connection.

18. The spacing device as recited in claim 17, wherein the detachable connection comprises at least one of a threaded, plugged, latched and clamped connection.

19. A spacing device for fixing the position of an implant cavity, in which a dental implant can be inserted, the spacing device comprising:
a support device for a drilling tool that drills the implant cavity in the jaw; and
a positioning element for positioning the spacing device on a section of jaw where the implant cavity is to be created, and the distance between the support device and the positioning element is fixed, and wherein the spacing device includes an attachment portion for connecting the spacing device to a dental instrument.

20. The spacing device as recited in claim 19, wherein the attachment portion comprises a detachable connection.

21. The spacing device as recited in claim 20, wherein the detachable connection comprises at least one of a threaded, plugged, latched and clamped connection.

22. The spacing device as recited in claim 19, wherein the attachment portion includes a shoulder and a connecting bush mounted within the shoulder.

23. An implantological guide instrument for use in jaw surgery for guiding a drilling tool mounted on a dental instrument with an attachment mechanism for connecting the guide instrument to a spacing device for fixing the position of an implant cavity.

24. The guide instrument as recited in claim 23, comprising a detachable connection.

25. The guide instrument as recited in claim 24, wherein the detachable connection comprises at least one of a threaded, plugged, latched and clamped connection.

26. The guide instrument as recited in claim 24, wherein the connection portion includes at least one spring arm, on which a catch and a recess are arranged.

27. The guide instrument as recited in claim 23, comprising a guide bush that accommodates and guides the drilling tool, wherein at last one guide pin is provided on the guide bush for guiding the dental instrument.

28. The guide instrument as recited in claim 27, wherein a bearing block is provided on the guide bush, and at least one guide pin is arranged on this bearing block.

29. The guide instrument as recited in claim 27, wherein the at least one guide pin is arranged such that at least a part of the dental instrument, preferably the instrument head, is movable along the at least one guide pin.

30. The guide instrument as recited in claim 27, wherein the at least one guide pin is arranged such that the dental instrument is movable with the at least one guide pin relative to the guide bush.

31. The guide instrument as recited in claim 23, comprising a slide bush as the bearing for at least a part of the dental instrument to be guided.

32. The guide instrument as recited in claim 31, comprising a guide bush that accommodates and guides the drilling tool, wherein at least one guide pin is provided on the guide bush for guiding the dental instrument, and wherein the slide bush has a bore hole for the at least one guide pin, in which a portion of the guide pin can engage.

33. The guide instrument as recited in claim 32, comprising at least one spring element that is arranged between the guide bush and the slide bush, and biases the slide bush against the guide bush.

34. The guide instrument as recited in claim 33, wherein a plurality of spring elements are provided that are constructed as helical springs, and wherein one guide pin is arranged inside each helical spring, wherein the guide pins protrude through bore holes in the bearing block and the diameter of the bore holes is smaller than the diameter of the helical springs, so that the helical springs rest on the side of bearing block that faces slide bush, so that, when a force is applied to the guide bush, the slide guide is movable together with the guide pins towards the bearing block against the spring force of the helical springs, wherein the guide pins slide through the bore holes in the bearing block.

35. The guide instrument as recited in claim 23, comprising a mounting portion for at least a part of the dental instrument, preferably the instrument head, wherein the mounting portion is attached to the slide bush.

36. The guide instrument as recited in claim 35, wherein the mounting portion is disposed rotatably relative to the slide bush.

37. The guide instrument as recited in claim 35, wherein the mounting portion includes at least two spring-loaded wings, between which the instrument head is able to be inserted, wherein the clearance between the wings is smaller than the diameter of instrument head, so that when the instrument head is inserted in the mounting portion, the wings are biased radially outwards and the free end of at least one wing has a protruding edge which engages in a recess on the instrument head when the instrument head is inserted in the mounting portion.

38. The spring device as recited in claim 1, wherein the spacing device is part of a toolkit for storing tools used to drill implant cavities, the toolkit comprising a carrier configured to receive the spacing device.

39. The spacing device as recited in claim 38, wherein the toolkit further comprises at least one of a guide instrument, a drilling tool for drilling implant cavities, an aid for selecting a spacing device and an implant.
